(19) United States
(12) Patent Application Publication
(10) Pub. No.: US 2019/0064534 A1
(43) Pub. Date: Feb. 28, 2019

(54) BEAM SHAPING LENS

(71) Applicant: Aether Systems Inc., Taipei (TW)

(72) Inventors: Yen-Chun Chou, Taipei (TW); Jonathan Liu, Taipei (TW)

(21) Appl. No.: 15/893,303

(22) Filed: Feb. 9, 2018

(30) Foreign Application Priority Data
Aug. 30, 2017 (TW) 106212867

(51) Int. Cl. G02B 27/09; G02B 3/08; G06K 9/00

(52) U.S. Cl. CPC G02B 27/0955; G02B 2003/0093; G06K 9/00255; G02B 3/08

(57) ABSTRACT

A beam shaping lens is disclosed. The beam shaping lens has a base on top side, a left wedge lens on bottom left of the base and a right wedge lens on bottom right of the base. Each of the wedge lens extended downwards from the base has a flat inner surface for light beams to enter and has a total internal reflection (TIR) surface for the light beams to reflect. The reflected light beams exit from a top side of the base to illuminate predetermined feature areas of a user's face especially peripheral areas in addition to the central area so that a face recognition system is able to capture features of a user's face in the feature areas.

### BACKGROUND

### Technical Field

The present invention relates to a lens, especially a beam shaping lens used in a security system for capturing user's facial feature in a face recognition application.

### Description of Related Art

Face recognition technologies are used in a security system for mobile phones, personal computers and wearable devices . . . etc., to prevent others from invading user's privacy. Existing face recognition system captures user's facial features focusing on a central area of a user's face only. However, the more the features are captured the higher the security is obtained, a higher security system for capturing more facial features is required to keep up with advanced technologies' development for electronic devices in recent years.

FIGS. 1A˜1C Show a Prior Art

FIG. 1A Shows a Prior Art for a Face Recognition System.

FIG. 1A shows that a user's face 10 is waiting for feature capture before a face recognition system (not shown).

A traditional flat-convex lens 12 is configured before the user's face 10. An IR light chip 13 is configured before the flat-convex lens 12. IR light beams 131 passes the flat-convex lens 12 to illuminate central areas 11 of the user's face 10. The prior art captures mainly central area of the user's face 10. More features other than the central area of a user's face to capture is desirable to obtain higher security for electronic devices in these days.

FIG. 1B Shows a Structure of the Flat-Convex Lens in the Prior Art.

FIG. 1B shows a traditional flat-convex lens 12 used in the prior art. The flat-convex lens 12 has a flat surface 121 on top and convex surface 122 on bottom side. Light beams 13 pass the convex surface 122 and exit from the flat surface 121 to shed light beams on the user's face 10.

FIG. 1C Shows an Optical Photograph for an Actual Illumination Effect for the Traditional Flat-Convex Lens.

The optical photograph of FIG. 1C reflects an actual illumination effect for the traditional flat-convex lens 22 with the IR light beams 131. FIG. 1C shows that the illuminated areas by the exiting IR light beams 131 are corresponding to the predetermined feature areas 11 in FIG. 1A.

### BRIEF DESCRIPTION OF THE DRAWINGS

FIGS. 1A˜1C show a prior art

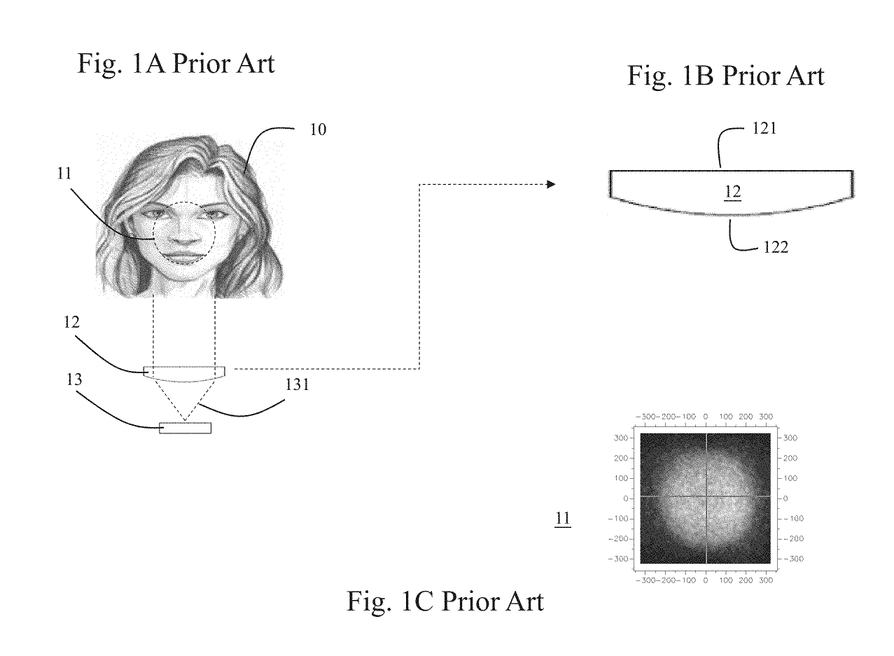

FIGS. 2A˜2C show a first embodiment according to the present invention.

FIGS. 3A˜3C show a second embodiment according to the present invention.

FIGS. 4A˜4C show a third embodiment according to the present invention.

FIGS. 5A˜5D show a fourth embodiment according to the present invention.

FIGS. 6A˜6D show a fifth embodiment according to the present invention.

FIGS. 7A˜7B show an assembly embodiment according to the present invention.

### DETAILED DESCRIPTION OF THE INVENTION

The present invention discloses a beam shaping lens. The beam shaping lens guides IR light beams to illuminate predetermined feature areas, especially peripheral areas surrounding central area, of a user's face so that a face recognition system is able to capture more features of a user's face for the face recognition system (not shown).

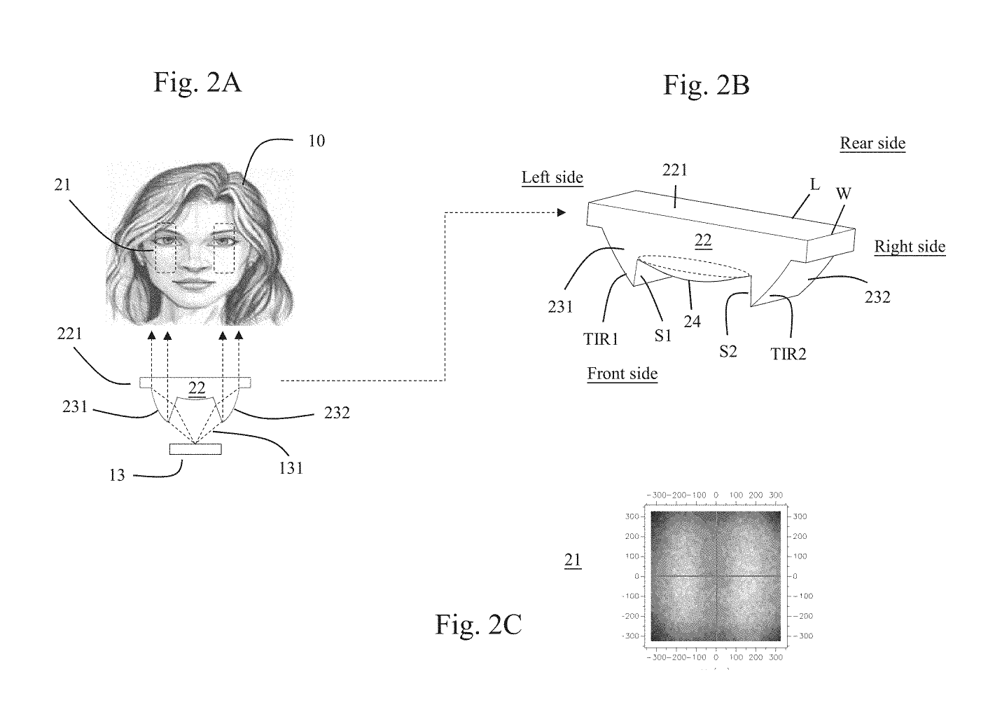

FIGS. 2A˜2C Show a First Embodiment According to the Present Invention.

FIG. 2A Shows a Feature Capture Application Through a First Beam Shaping Lens Over a User's Face.

FIG. 2A shows that a user's face 10 is waiting for feature capture before a face recognition system (not shown). A first beam shaping lens 22 is configured before the user's face 10. An IR light chip 13 is configured before the beam shaping lens 22. The beam shaping lens 22 has a base 221 on top. A left wedge lens 231 and a right wedge lens 232 are configured on a bottom side of the base 221. IR light beams 131 passes the beam shaping lens 22 to illuminate predetermined feature areas 21 of the user's face 10. FIG. 2A shows that the base 221 is rectangular as an example only, it can be circular or other shapes. The rectangular base 221 has a width W and length L.

FIG. 2B Shows a Structure of the First Beam Shaping Lens According to the Present Invention.

The beam shaping lens 22 has a base 221 configured on top, and has a left wedge lens 231 and a right wedge lens 232 configured on bottom side of the base 221.

The left wedge lens 231 is configured on a bottom left of the base 221. The left wedge lens 231 has a first incident surface S1 for light beams 131 to enter, and has a first Total Internal Reflection surface TIR1 for the light beams 131 to reflect.

The right wedge lens 232 is configured on a bottom right of the base 221. The right wedge lens 232 has a second incident surface S2 for light beams 131 to enter, and has a second Total Internal Reflection surface TIR2 for the light beams 131 to reflect.

A central lens 24 is configured in between the left wedge lens 231 and the right wedge lens 232, the central lens 24 can be one of concave lens or convex lens.

The first incident surface S1 is flat; and the second incident surface S2 is flat and configured opposite to the first incident surface S1.

FIG. 2C Shows an Optical Photograph for an Actual Illumination Effect for the First Beam Shaping Lens.

The optical photograph of FIG. 2C reflects an actual illumination effect for the first beam shaping lens 22 with the IR light beams 131. FIG. 2C shows that the illuminated areas by the exiting IR light beams 131 are corresponding to the predetermined feature areas 21 in FIG. 2A.

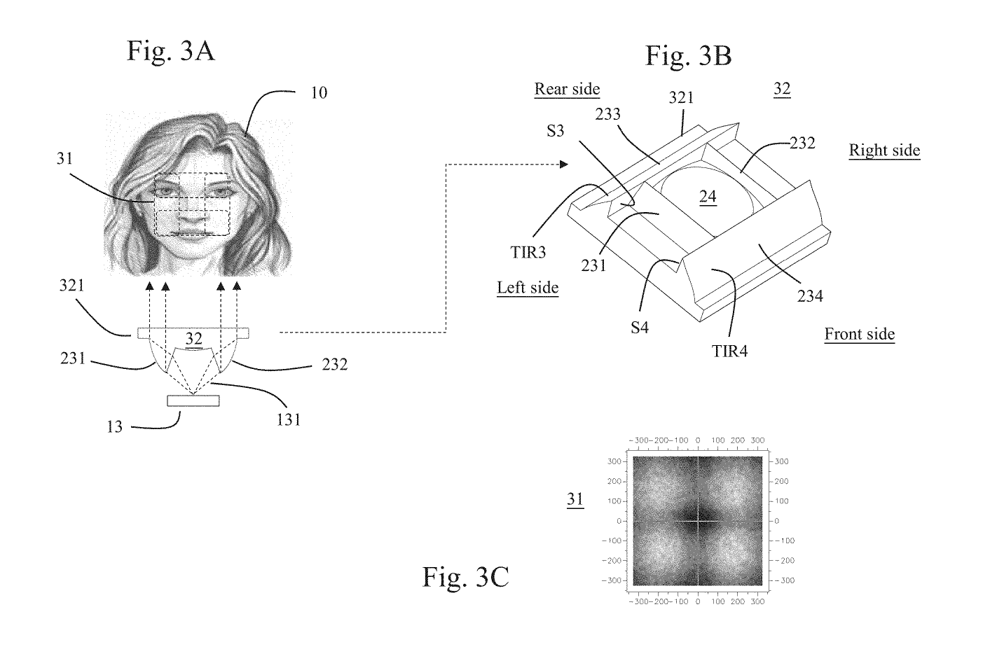

FIGS. 3A˜3C Show a Second Embodiment According to the Present Invention.

FIG. 3A Shows a Feature Capture Application Through a Second Beam Shaping Lens Over a User's Face.

FIG. 3A shows a second beam shaping lens 32 which is similar to the first beam shaping lens 22. Comparing with the first beam shaping lens 22 which has a first and second wedge lens 231, 232 configured on bottom side; the second beam shaping lens 32 has additional two wedge lens 233, 234 configured on bottom side. FIG. 3A shows that a user's face 10 is waiting for feature capture before a face recognition system (not shown).

FIG. 3B Shows a Structure of the Second Beam Shaping Lens According to the Present Invention.

A second beam shaping lens 32 is configured before the user's face 10. An IR light chip 13 is configured before the beam shaping lens 32. The second beam shaping lens 32 has a base 321 on top side and has four wedge lens 231, 232, 233, 234 configured on bottom side.

A rear wedge lens 233 is configured on a bottom rear of the base 321, the rear wedge lens 233 has a third incident surface S3 for light beams 131 to enter, and has a third Total Internal Reflection surface TIR3 for the light beams 131 to reflect.

A front wedge lens 234 is configured on a bottom front of the base 321, and has a fourth incident surface S4 for light beams 131 to enter, and has a fourth Total Internal Reflection surface TIR4 for the light beams 131 to reflect.

The third incident surface S3 is flat and normal to the first incident surface S1;

The fourth incident surface S4 is flat and configured opposite to the third incident surface S3.

FIG. 3C Shows an Optical Photograph for an Actual Illumination Effect for the Second Beam Shaping Lens.

The optical photograph of FIG. 3C reflects an actual illumination effect for the second beam shaping lens 32 with the IR light beams 131. FIG. 3C shows that the illuminated areas by the exiting IR light beams 131 are corresponding to the predetermined feature areas 31 in FIG. 3A.

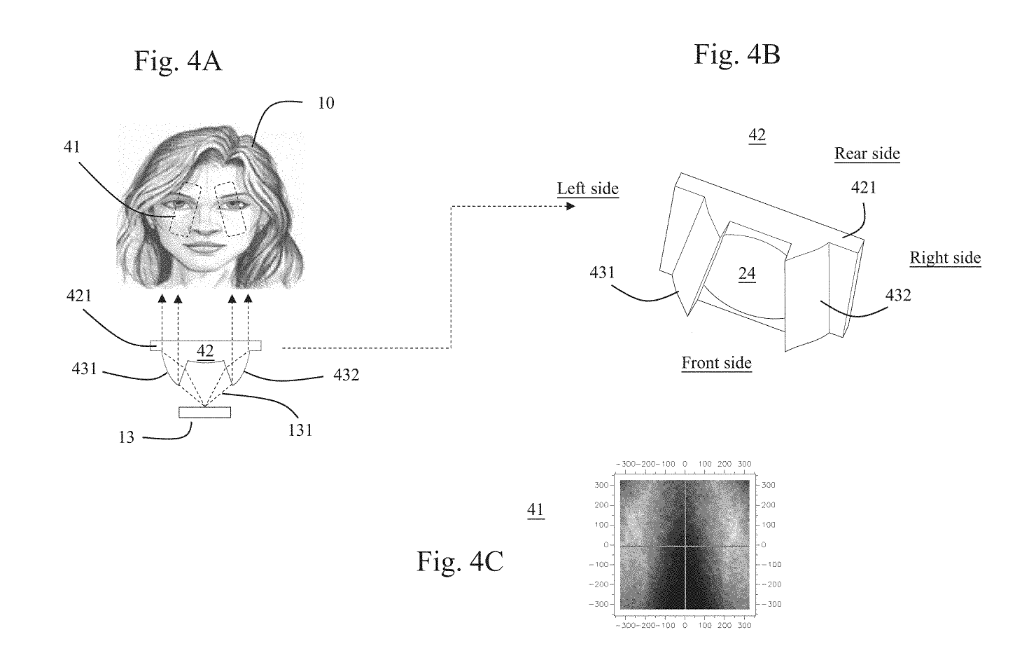

FIGS. 4A˜4C Show a Third Embodiment According to the Present Invention.

FIG. 4A Shows a Feature Capture Application Through a Third Beam Shaping Lens Over a User's Face.

A third beam shaping lens 42 is configured before the user's face 10. An IR light chip 13 is configured before the beam shaping lens 42. The beam shaping lens 42 has a base 421 on top. A left wedge lens 431 and a right wedge lens 432 are configured on a bottom side of the base 421. IR light beams 131 passes the third beam shaping lens 42 to illuminate predetermined feature areas 41 of the user's face 10.

FIG. 4B Shows a Structure of the Third Beam Shaping Lens According to the Present Invention.

The third beam shaping lens 42 has a base 421 configured on top, and has a left wedge lens 431 and a right wedge lens 432 configured on bottom side of the base 421. The left wedge lens 431 and the right wedge lens 432 are similar to the left wedge lens 231 and the right wedge lens 232 of the first beam shaping lens 22 (see FIG. 2B). The difference there between is that the left wedge lens 231 and the right wedge lens 232 for the first beam shaping lens 22 (see FIG. 2B) are configured in-parallel, however the left wedge lens 431 and the right wedge lens 432 for the third beam shaping lens 42 are configured in non-parallel.

FIG. 4C Shows an Optical Photograph for an Actual Illumination Effect for the Third Beam Shaping Lens.

The optical photograph of FIG. 4C reflects an actual illumination effect for the third beam shaping lens 42 with the IR light beams 131. FIG. 4C shows that the illuminated areas by the exiting IR light beams 131 are corresponding to the predetermined feature areas 41 in FIG. 4A.

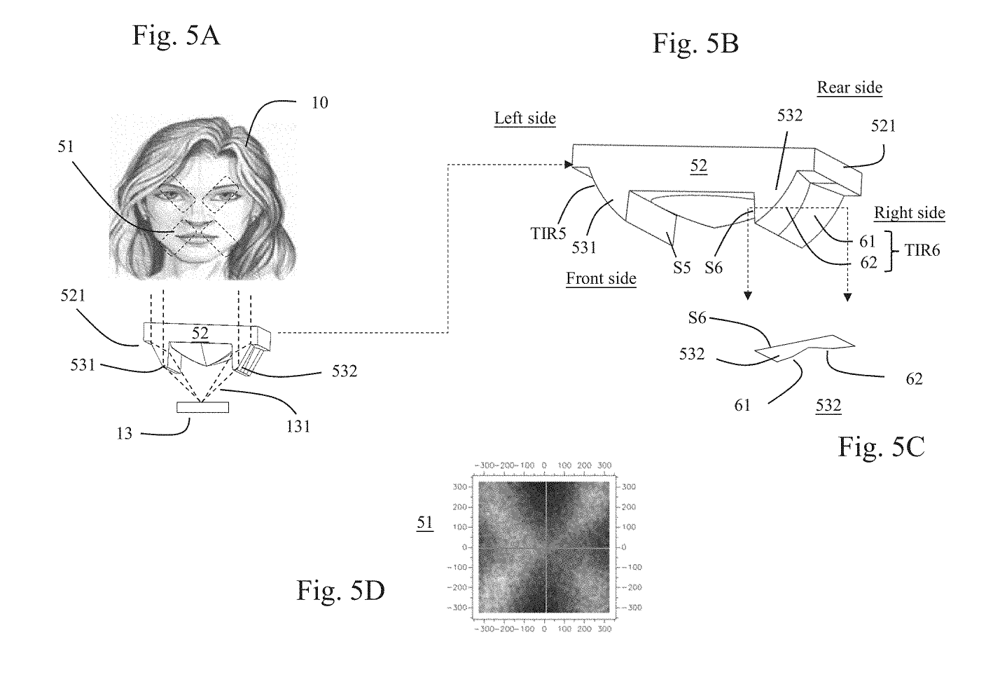

FIGS. 5A˜5D Show a Fourth Embodiment According to the Present Invention.

FIG. 5A Shows a Feature Capture Application Through a Fourth Beam Shaping Lens Over a User's Face.

A fourth beam shaping lens 52 is configured before the user's face 10. An IR light chip 13 is configured before the beam shaping lens 52. The fourth beam shaping lens 52 has a base 521 on top. A left wedge lens 531 and a right wedge lens 532 are configured on a bottom side of the base 521. IR light beams 131 passes the fourth beam shaping lens 52 to illuminate predetermined feature areas 51 of the user's face 10.

FIG. 5B Shows a Structure of the Fourth Beam Shaping Lens According to the Present Invention.

The fourth beam shaping lens 52 has a base 521 configured on top, and has a left wedge lens 531 and a right wedge lens 532 configured on bottom side of the base 521.

The left wedge lens 531 is configured on a bottom left of the base 521. The left wedge lens 531 has a fifth incident surface S5 for light beams 131 to enter and has a fifth Total Internal Reflection surface TIR5 for the light beams 131 to reflect.

The right wedge lens 532 is configured on a bottom right of the base 521. The right wedge lens 532 has a sixth incident surface S6 for light beams 131 to enter, and has a sixth Total Internal Reflection surface TIR6 for the light beams 131 to reflect.

The sixth Total Internal Reflection TIR6 surface further comprises a sub-first TIR surface 61 and a sub-second TIR surface 62; the sub-first TIR surface 61 faces a first direction, and the sub-second TIR surface 62 faces a second direction, the second direction is different from the first direction. FIG. 5B shows that the first direction and the section direction are facing outwards.

FIG. 5C Shows a Section View for the Right Wedge Lens.

FIG. 5C shows a section view for the right wedge lens 532. The sixth Total Internal Reflection TIR6 surface further comprises a sub-first TIR surface 61 and a sub-second TIR surface 62; the sub-first TIR surface 61 faces a first direction, and the sub-second TIR surface 62 faces a second direction, the second direction is different from the first direction. FIG. 5C shows that the first direction and the section direction are facing outwards.

FIG. 5D Shows an Optical Photograph for an Actual Illumination Effect for the Third Beam Shaping Lens.

The optical photograph of FIG. 5D reflects an actual illumination effect for the fourth beam shaping lens 52 with the IR light beams 131. FIG. 5D shows that the illuminated areas by the exiting IR light beams 131 are corresponding to the predetermined feature areas 51 in FIG. 5A.

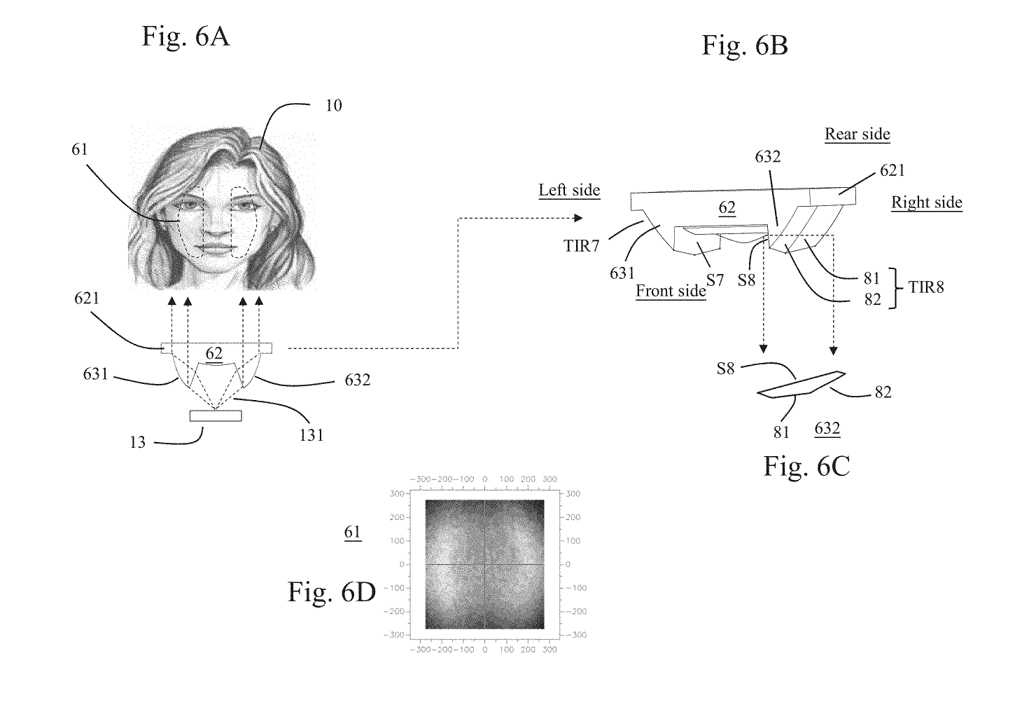

FIGS. 6A˜6D Show a Fifth Embodiment According to the Present Invention.

FIG. 6A Shows a Feature Capture Application Through a Fifth Beam Shaping Lens Over a User's Face.

A fifth beam shaping lens 62 is configured before the user's face 10. An IR light chip 13 is configured before the beam shaping lens 62. The fifth beam shaping lens 62 has a base 621. A left wedge lens 631 and a right wedge lens 632 are configured on a bottom side of the base 621. IR light beams 131 passes the fifth beam shaping lens 62 to illuminate predetermined feature areas 61 of the user's face 10.

FIG. 6B Shows a Structure of the Fifth Beam Shaping Lens According to the Present Invention.

The fifth beam shaping lens 62 is similar to the fourth shaping lens 52 (see FIG. 5B), the difference there between is that the sub-first TIR surface 61 and the sub-second TIR surface 62 faces outwards for the fourth beam shaping lens 52, however the sub-first TIR surface 81 and the sub-second TIR surface 82 for the fifth beam shaping lens 62 faces inwards.

The fifth beam shaping 62 has a base 621 configured on top, and has a left wedge lens 631 and a right wedge lens 632 configured on bottom side of the base 621.

The left wedge lens 631 is configured on a bottom left of the base 621. The left wedge lens 631 has a seventh incident surface S7 for light beams 131 to enter and has a seventh Total Internal Reflection surface TIR7 for the light beams 131 to reflect.

The right wedge lens 632 is configured on a bottom right of the base 621. The right wedge lens 632 has an eighth incident surface S8 for light beams 131 to enter, and has an eighth Total Internal Reflection surface TIR8 for the light beams 131 to reflect.

The eighth Total Internal Reflection TIR8 surface further comprises a sub-first TIR surface 81 and a sub-second TIR surface 82; the sub-first TIR surface 81 faces a first direction, and the sub-second TIR surface 82 faces a second direction, the second direction is different from the first direction. FIG. 6B shows that the first direction and the section direction are facing inwards.

FIG. 6C Shows a Section View for the Right Wedge Lens for the Fifth Beam Shaping Lens.

FIG. 6C shows a section view for the right wedge lens 632. The eighth Total Internal Reflection surface TIR8 is composed of a sub-first TIR surface 81 and a sub-second TIR surface 82. The sub-first TIR surface 81 faces a first direction, and the sub-second TIR surface 82 faces a second direction. The second direction is different from the first direction. FIG. 6C shows that the first direction and the section direction are facing inwards.

FIG. 6D Shows an Optical Photograph for an Actual Illumination Effect for the Fifth Beam Shaping Lens.

The optical photograph of FIG. 6D reflects an actual illumination effect for the fifth beam shaping lens 62 with the IR light beams 131. FIG. 6C shows that the illuminated areas by the exiting IR light beams 131 are corresponding to the predetermined feature areas 61 in FIG. 6A.

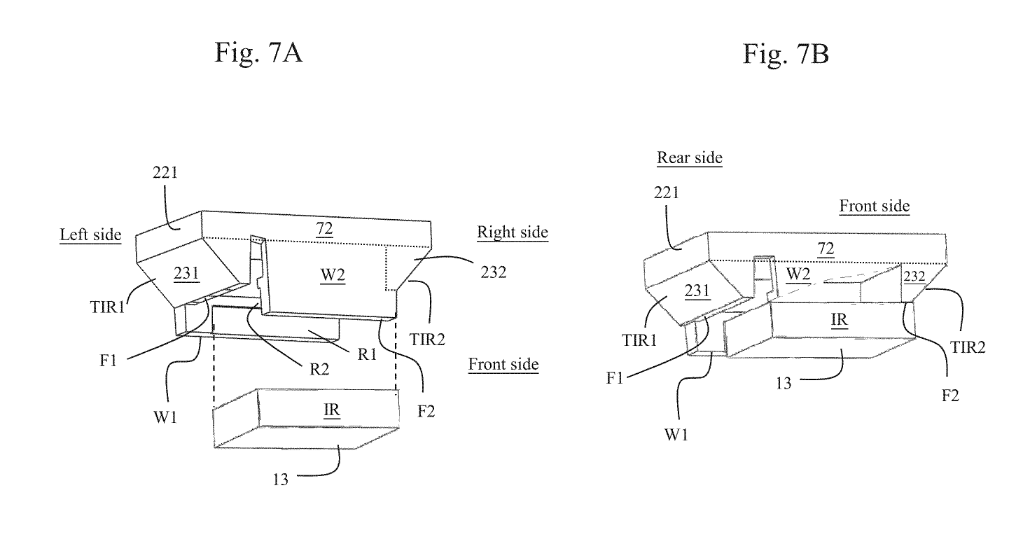

FIGS. 7A˜7B Show an Assembly Embodiment According to the Present Invention.

FIG. 7A Shows a Structure of the Beam Shaping Lens Assembled with an IR Light Chip According to the Present Invention.

The sixth beam shaping lens 72 is similar to the first beam shaping lens 22 (see FIG. 2B) but the beam shaping lens 72 has additional two side walls W1, W2 configured on bottom of the base 221.

The sixth beam shaping lens 72 has a base 221 configured on top, and has a left wedge lens 231 and a right wedge lens 232 configured on bottom side of the base 221.

The left wedge lens 231 is configured on a bottom left of the base 221 and the right wedge lens 232 is configured on a bottom right of the base 221. A first side wall W1 is configured on bottom rear of the base 221 and a second side wall W2 is configured on bottom front of the base 221.

The left wedge lens 231 has a bottom flat F1 and the right wedge lens 232 has a bottom flat F2. The first wall W1 has a first recess R1 and the second wall W2 has a second recess R2. The second recess R2 is opposite to the first recess R1. An IR light chip 13 is prepared waiting to mount on bottom of the sixth beam shaping lens 72.

FIG. 7B Shows the Sixth Beam Shaping Lens with IR Light Chip Assembled on Bottom According to the Present Invention.

FIG. 7B show the IR light chip 13 is mounted in and between the first recess R1 and the second recess R2. Further a top surface of the IR light chip 13 touches the flat bottom of the right wedge lens 232 for Z-axis positioning. Since the first recess R1 and the second recess R2 are shallow, the flat bottom F2 can be helpful in Z-axis positioning for the IR light chip 13.

While several embodiments have been described by way of example, it will be apparent to those skilled in the art that various modifications may be configured without departs from the spirit of the present invention. Such modifications are all within the scope of the present invention, as defined by the appended claims.

Numeric system

10 user's face
13 IR light chip
131 light beams
21,31,41,51,61 feature areas
22, 32, 42, 52, 62, 72 beam shaping lens
221, 321, 421, 521, 621 base
231, 232, 233, 234, 431, 432, 531, 532, 631, 632 wedge lens
24 central lens
61, 81 sub-first TIR surface
62, 82 sub-second TIR surface
F1, F2 bottom flat
R1, R2 recess
S1, S2, S3, S4, S5, S6, S7, S8 incident surface
TIR Total Internal Reflection
W1, W2 wall

What is claimed is:

1. A beam shaping lens, comprising:
a base;
a left wedge lens configured on a bottom left of the base, having a first incident surface for light beams to enter, and has a first Total Internal Reflection (TIR) surface for the light beams to reflect;
a right wedge lens configured on a bottom right of the base, having a second incident surface for light beams to enter, and has a second Total Internal Reflection (TIR) surface for the light beams to reflect; wherein
the first incident surface is flat; and
the second incident surface is flat and configured opposite to the first incident surface.

2. A beam shaping lens as claimed in claim 1, further comprising:
a front wedge lens configured on a bottom front of the base, having a third incident surface for light beams to enter, and has a third Total Internal Reflection (TIR) surface for the light beams to reflect;
a rear wedge lens configured on a bottom rear of the base, having a fourth incident surface for light beams to enter, and has a fourth Total Internal Reflection (TIR) surface for the light beams to reflect;
the third incident surface is flat; and
the fourth incident surface, configured opposite to the third incident surface, is flat.

3. A beam shaping lens as claimed in claim 1, wherein
the first incident surface is in parallel with the second incident surface.

4. A beam shaping lens as claimed in claim 1, wherein
the first incident surface is in non-parallel with the second incident surface.

5. A beam shaping lens as claimed in claim 1, wherein
the first TIR surface further comprising a sub-first TIR surface and a sub-second TIR surface;
the sub-first TIR surface faces a first direction, and the sub-second TIR surface faces a second direction different from the first direction;
the second TIR surface further comprising a sub-third TIR surface and a sub-fourth TIR surface;
the sub-third TIR surface faces a third direction, and the sub-fourth TIR surface faces a fourth direction different from the third direction.

6. A beam shaping lens as claimed in claim 5, wherein
the first direction and the second direction are facing outwards; and
the third direction and the fourth direction are facing outwards.

7. A beam shaping lens as claimed in claim 5, wherein
the first direction and the second direction are facing inwards; and
the third direction and the fourth direction are facing inwards.

8. A beam shaping lens as claimed in claim 1, further comprising:
a first wall configured on front bottom of the lens;
a second wall configured on rear bottom of the lens;
a first recess configured on an inner side of the first wall; and
a second recess configured on an inner side of the second wall.

9. A beam shaping lens as claimed in claim 8, further comprising:
an infrared chip configured between the first recess and the second recess.

10. A beam shaping lens as claimed in claim 9, further comprising:
the right wedge has a bottom flat; and
a right top end of the infrared chip touches a bottom surface of the bottom flat.

11. A beam shaping lens as claimed in claim 1, further comprising:
a central lens configured in between the left wedge lens and the right wedge lens.

12. A beam shaping lens as claimed in claim 11, wherein the central lens is one of concave lens and convex lens.

13. A beam shaping lens as claimed in claim 1, wherein
the base is rectangular, and
the rectangular base has a width and length.

14. A beam shaping lens as claimed in claim 13, wherein the first incident surface is in parallel with the width direction of the rectangular base.

15. A beam shaping lens as claimed in claim 13, wherein the first incident surface is in parallel with the length direction of the rectangular base.
